(19) United States
(12) Patent Application Publication
(10) Pub. No.: US 2011/0249021 A1
(43) Pub. Date: Oct. 13, 2011

(54) DISPLAY DEVICE, DISPLAY METHOD, DISPLAY CONTROL PROGRAM, AND RECORDING MEDIUM

(75) Inventors: Shigeto Yoshida, Osaka (JP); Kentarou Imamura, Osaka (JP)

(73) Assignee: Sharp Kabushiki Kaisha, Osaka-shi ,Osaka (JP)

(21) Appl. No.: 12/998,894

(22) PCT Filed: Nov. 17, 2009
(86) PCT No.: PCT/JP2009/006164

§ 371 Date: Jun. 14, 2011

(30) Foreign Application Priority Data
Apr. 24, 2009 (JP) 2009-106785

(51) Int. Cl. G09G 5/00

(52) U.S. Cl. 345/606

(57) ABSTRACT

A display device of at least one embodiment of the present invention includes: an interpolation image data creating section; and a control section, the interpolation image data creating section creating at least one piece of interpolation image data for adjacent pixels which are adjacent to each other in a direction from a curve beginning point toward a curve ending point of a curved surface of a lens, said at least one piece of interpolation image data having a gray scale level(s) between gray scale levels of corresponding pieces of original image data corresponding to the respective adjacent pixels, and the control section selecting pieces of image data the number of which is same as the number of corresponding pixels such that the pieces of image data thus selected are at substantially even intervals in a case where the pieces of original image data and said at least one piece of interpolation image data are arranged in order.

### TECHNICAL FIELD

The present invention relates to a display device. In particular, the present invention relates to (i) a display device having a lens on its display surface and (ii) a display method for use in the display device.

### BACKGROUND ART

Conventionally, there has been proposed a display device which has a lens on its display surface so that (i) in a case of a tiling technique in which a plurality of liquid crystal display panels are arranged, seams between the plurality of liquid crystal display panels are difficult to perceive (i.e., seamless display is achieved) or (ii) a peripheral part of a liquid crystal display panel is difficult to perceive and a display area is increased.

(Patent Literature 1)

For example, Patent Literature 1 discloses a technique of (i) providing a convex lens on a display surface of a display and (ii) reducing a pixel pitch in a region, of the display, which corresponds to a curved portion of the convex lens.

The technique suppresses an extended display, which occurs because an image is displayed via the convex lens.

(Patent Literature 2)

Patent Literature 2 discloses a technique in which (i) convex lenses are provided on display surfaces of a plurality of display devices arranged and (ii) a focal length of each of the convex lenses is determined so that an enlarged virtual image is displayed.

### CITATION LIST

### Patent Literatures

Patent Literature 1

Japanese Translation of PCT Patent Application, Tokuhyo, No. 2004-524551 A (Publication Date: Aug. 12, 2004)

Patent Literature 2

Japanese Patent Application Publication, Tokukaihei, No. 3-5787 A (Publication Date: Jan. 11, 1991)

### SUMMARY OF INVENTION

### Technical Problem

However, the technique described in Patent Literature 1 has a problem in which it is difficult, in terms of manufacturing, to change the pixel pitch according to a curve of the convex lens, and therefore the technique is poor in versatility. The technique described in Patent Literature 1 further has a problem in which a high-accuracy positioning is required when the convex lens is provided.

Further, the technique described in Patent Literature 2 has a problem in which (i) a size of a device tends to be large and (ii) a position, in which the virtual image is displayed so that the seams are difficult to perceive, tends to be limited.

The present invention has been made in view of the problems, and an object of the present invention is to provide a display device and a display method each of which is excellent in versatility, is easy to produce, has a simple configuration, and is capable of suppressing an extended display.

### Solution to Problem

In order to achieve the above object, the display device in accordance with the present invention includes: a display section; an optical section which covers a display surface of the display section; an interpolation image data creating section; and a control section, the display section having pixels arranged in a matrix manner, the optical section including a lens having (i) a flat region having a flat surface and (ii) a curve region having a convexly curved surface, the pixels corresponding to respective pieces of image data which serve as pieces of original image data, the interpolation image data creating section creating at least one piece of interpolation image data for adjacent pixels which are in a region facing the curve region and adjacent to each other in a direction from a curve beginning point toward a curve ending point of the curved surface, said at least one piece of interpolation image data having a gray scale level(s) between gray scale levels of corresponding pieces of original image data corresponding to the respective adjacent pixels, and the control section selecting pieces of image data from the pieces of original image data and said at least one piece of interpolation image data so that, in a case where (a) the pieces of original image data are arranged in order of corresponding pixels and (b) said at least one piece of interpolation image data is arranged between the corresponding pieces of original image data corresponding to the respective adjacent pixels so that said at least one piece of interpolation image data thus arranged has a continuous gray scale level(s), the pieces of image data thus selected are at substantially even intervals and the number of the pieces of image data thus selected is same as the number of the corresponding pixels.

The display device in accordance with the present invention is configured such that the number of said at least one piece of interpolation image data to be created is determined in accordance with a factor by which images from the pixels are magnified through the curve region of the optical section.

The display device of the present invention is configured such that the number of said at least one piece of interpolation image data to be created is determined in accordance with a factor by which an image from a corresponding one of the pixels is magnified through the curve region of the optical section.

In order to achieve the above object, the method in accordance with the present invention is a display method for use in a display device including: a display section; and an optical section which covers a display surface of the display section; the display section having pixels arranged in a matrix manner, the optical section including a lens having (i) a flat region having a flat surface and (ii) a curve region having a convexly curved surface, the pixels corresponding to respective pieces of image data which serve as pieces of original image data, said method, including the steps of: creating at least one piece of interpolation image data for adjacent pixels which are in a region facing the curve region and adjacent to each other in a direction from a curve beginning point toward a curve ending point of the curved surface, said at least one piece of interpolation image data having a gray scale level(s) between gray scale levels of corresponding pieces of original image data corresponding to the respective adjacent pixels; selecting pieces of image data from the pieces of original image data and said at least one piece of interpolation image data so that, in a case where (a) the pieces of original image data are arranged in order of corresponding pixels and (b) said at least one piece of interpolation image data is arranged between the corresponding pieces of original image data corresponding to the respective adjacent pixels so that said at least one piece of interpolation image data thus arranged has a continuous gray scale level(s), the pieces of image data thus selected are at substantially even intervals and the number of the pieces of image data thus selected is same as the number of the corresponding pixels; and displaying the pieces of image data thus selected.

The display device in accordance with the present invention is configured such that the number of said at least one piece of interpolation image data to be created is determined in accordance with a factor by which images from the pixels are magnified through the curve region of the optical section.

According to the above configuration and the method, said at least one piece of interpolation image data is created. Said at least one piece of interpolation image data is a piece(s) of image data having a gray scale level(s) between the gray scale levels of the corresponding pieces of original image data corresponding to the respective adjacent pixels, which are adjacent to each other in a direction in which the curved surface of the lens is curved.

An image from each of the pixels is magnified when seen through the lens having the convexly curved surface. As a result, the image displayed on the display section is prone to an extended display, in which an original image supposed to be displayed is extended.

According to the above configuration and the method, said at least one piece of interpolation image data is created. Said at least one piece of interpolation image data has the gray scale level(s) between the gray scale levels of the corresponding pieces of original image data, which are supposed to be supplied to the respective adjacent pixels for which said at least one piece of interpolation image data is created.

Therefore, in the case where (i) the pieces of original image data are arranged in order of the corresponding pixels and (ii) said at least one piece of interpolation image data is arranged between the corresponding pieces of original image data corresponding to the respective adjacent pixels so that said at least one piece of interpolation image data thus arranged has a continuous gray scale level(s), such an image data group scarcely causes an extended display even if it is displayed via the lens.

Further, according to the above configuration and the method, the pieces of image data are selected from the pieces of original image data and said at least one piece of interpolation image data arranged like above so that the pieces of image data thus selected are at substantially even intervals and the number of the pieces of image data thus selected is same as the number of the corresponding pixels. Then, a display is caused by the pieces of image data thus selected.

That is, the pieces of image data for use in the display are pieces of thinned-out image data which are selected, from the image data group taking into consideration magnification of images by the lens, so that the pieces of image data thus selected are located at substantially even intervals. This makes it possible to achieve a more natural and smooth display when the images are seen through the lens. Accordingly, it is possible to suppress an extended display.

Further, in a case where the number of said at least one piece of interpolation image data to be created is determined in accordance with the factor by which the images from the pixels are magnified through the curve region of the optical section, the number tends to be suitable for a shape of the curved surface of the optical section. Therefore, an image data group, which is constituted by the pieces of interpolation image data and the pieces of original image data arranged like above, scarcely causes an extended display when seen through the lens.

Further, in a case where the number of said at least one piece of interpolation image data to be created is determined in accordance with the factor by which the image from the corresponding one of the pixels is magnified through the curve region of the optical section, the number tends to be suitable for a shape of a corresponding part of the curve surface of the optical section. This makes it easy to obtain an image data group which further scarcely causes an extended display.

Father, according to the configuration and the method, it is possible to suppress an extended display without a configuration and a method which make it difficult to produce the display device or make a structure complicated. That is, for example, it is possible to suppress an extended display without changing size or pitch of the pixels.

Further, according to the configuration and the method, it is easy to change the number or the gray scale level(s) of said at least one piece of interpolation image data to be created. Accordingly, the configuration and the method are excellent in versatility and thus are easily applicable to various lenses.

As has been described, the configuration and the method make it possible to provide a display device and a display method each of which is excellent in versatility, is easy to produce, has a simple configuration, and is capable of suppressing an extended display.

Note here that “the substantially even intervals” means that, if it is impossible to select the pieces of image data at exactly even intervals due to a relation between (i) the number of the pieces of original image data and said at least one piece of interpolation image data and (ii) the number of the corresponding pixels, the pieces of image data can be selected at intervals as close as possible to the exactly even intervals as appropriate.

### Advantageous Effects of Invention

As described above, the display device in accordance with the present invention includes: a display section; an optical section; an interpolation image data creating section; and a control section, the display section having pixels arranged in a matrix manner, the optical section including a lens having (i) a flat region having a flat surface and (ii) a curve region having a convexly curved surface, the pixels corresponding to respective pieces of image data which serve as pieces of original image data, the interpolation image data creating section creating at least one piece of interpolation image data for adjacent pixels which are in a region facing the curve region and adjacent to each other in a direction from a curve beginning point toward a curve ending point of the curved surface, said at least one piece of interpolation image data having a gray scale level(s) between gray scale levels of corresponding pieces of original image data corresponding to the respective adjacent pixels, and the control section selecting pieces of image data from the pieces of original image data and said at least one piece of interpolation image data so that, in a case where (a) the pieces of original image data are arranged in order of corresponding pixels and (b) said at least one piece of interpolation image data is arranged between the corresponding pieces of original image data corresponding to the respective adjacent pixels so that said at least one piece of interpolation image data thus arranged has a continuous gray scale level(s), the pieces of image data thus selected are at substantially even intervals and the number of the pieces of image data thus selected is same as the number of the corresponding pixels.

Further, the method for use in the display device in accordance with the present invention is a display method for use in a display device including: a display section; and an optical section; the display section having pixels arranged in a matrix manner, the optical section including a lens having (i) a flat region having a flat surface and (ii) a curve region having a convexly curved surface, the pixels corresponding to respective pieces of image data which serve as pieces of original image data, said method, including the steps of: creating at least one piece of interpolation image data for adjacent pixels which are in a region facing the curve region and adjacent to each other in a direction from a curve beginning point toward a curve ending point of the curved surface, said at least one piece of interpolation image data having a gray scale level(s) between gray scale levels of corresponding pieces of original image data corresponding to the respective adjacent pixels; selecting pieces of image data from the pieces of original image data and said at least one piece of interpolation image data so that, in a case where (a) the pieces of original image data are arranged in order of corresponding pixels and (b) said at least one piece of interpolation image data is arranged between the corresponding pieces of original image data corresponding to the respective adjacent pixels so that said at least one piece of interpolation image data thus arranged has a continuous gray scale level(s), the pieces of image data thus selected are at substantially even intervals and the number of the pieces of image data thus selected is same as the number of the corresponding pixels; and displaying the pieces of image data thus selected.

Therefore, it is possible to provide a display device and a display method each of which is excellent in versatility, is easy to produce, has a simple configuration, and is capable of suppressing an extended display.

### BRIEF DESCRIPTION OF DRAWINGS

FIG. 1, showing an embodiment of the present invention, is a view illustrating how a liquid crystal display device looks when seen from its display surface.

FIG. 2, showing the embodiment of the present invention, is a cross-sectional view taken along line A-A of FIG. 1.

FIG. 3, showing the embodiment of the present invention, is a view schematically illustrating how the liquid crystal display device is configured.

FIG. 4, showing the embodiment of the present invention, is a view illustrating how a display is magnified by a lens.

FIG. 5, showing the embodiment of the present invention, is a view illustrating how a display region is extended.

FIG. 6, showing the embodiment of the present invention, is a view illustrating original image data and interpolation image data.

FIG. 7, showing the embodiment of the present invention, is a view schematically illustrating how the interpolation image data is created.

FIG. 8, showing the embodiment of the present invention, is a view illustrating how the number of interpolations is found.

FIG. 9, showing the embodiment of the present invention, is a view illustrating a region in which the interpolation image data is created.

FIG. 10, showing the embodiment of the present invention, is a view illustrating how the number of interpolations is found.

FIG. 11, showing the embodiment of the present invention, is a view illustrating a region in which the interpolation image data is created.

FIG. 12, showing the embodiment of the present invention, is a view illustrating the region in which the interpolation image data is created.

FIG. 13, showing the embodiment of the present invention, is a view illustrating how thinned-out image data is selected.

FIG. 14, showing the embodiment of the present invention, is a view illustrating a relation between a radius of curvature of a lens and a lens width.

FIG. 15, showing another embodiment of the present invention, is a view schematically illustrating how a liquid crystal display device is configured.

FIG. 16, showing a further embodiment of the present invention, is a view schematically illustrating how a liquid crystal display device is configured.

### DESCRIPTION OF EMBODIMENTS

### Embodiment 1

The following description discusses a first embodiment of the present invention.

(Display Device)

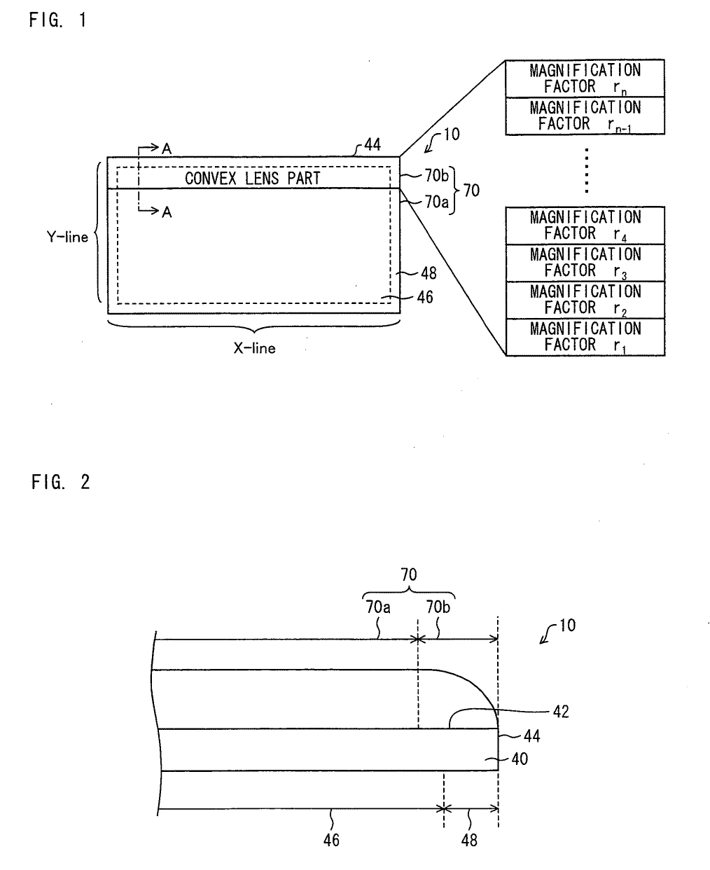

FIG. 1 schematically illustrates how a liquid crystal display device of the present embodiment looks when seen from its display surface. FIG. 2 is a cross-sectional view taken along line A-A of FIG. 1.

As illustrated in FIG. 1, a liquid crystal display device 10, which serves as a display device of the present embodiment, has a display surface covered with a lens 70 which serves as an optical section.

The lens 70 has (i) a flat region 70a whose surface is flat and (ii) a curve region 70b whose surface is curved so as to function as a convex lens. The curve region 70b is provided along a long side, of the display surface having a rectangle shape, which is one of four sides of the display surface.

The following description is based on FIG. 2, which illustrates a cross-sectional surface. As illustrated in FIG. 2, the liquid crystal display device 10 includes (i) a liquid crystal display panel 40 serving as a display section and (ii) the lens 70 provided on a display surface 42 of the liquid crystal display panel 40.

In the liquid crystal display panel 40, pixels (not illustrated) are arranged in a matrix manner. The pixels form lines intersect with each other.

The curve region 70b of the lens 70 is provided in the vicinity of an end side 44 of the liquid crystal display panel 40.

The display surface 42 has (i) a display region 46 in which an image etc. is displayed and (ii) a non-display region 48, such as a so-called frame, in which no image etc. is displayed. The lens 70 is provided so that the curve region 70b covers both of the display region 46 and the non-display region 48.

The foregoing description discussed, with reference to FIGS. 1 and 2, a configuration in which the curve region 70b is provided along a long side, of the display surface, which is one of the four sides of the display surface. Note, however, that the curve region 70b is not particularly limited as to its position in the lens 70, the number of curve regions 70b, and the like. For example, the curve region 70b can be provided along a short side. Alternatively, the curve region 70b can be provided along not only one (1) side but also two through four sides.

The lens 70 does not necessarily have to have the flat region 70a. For example, it is possible to employ a configuration in which the lens 70 has no flat region 70a and an entire lens 70 is constituted by the curve region 70b.

(Overall Configuration)

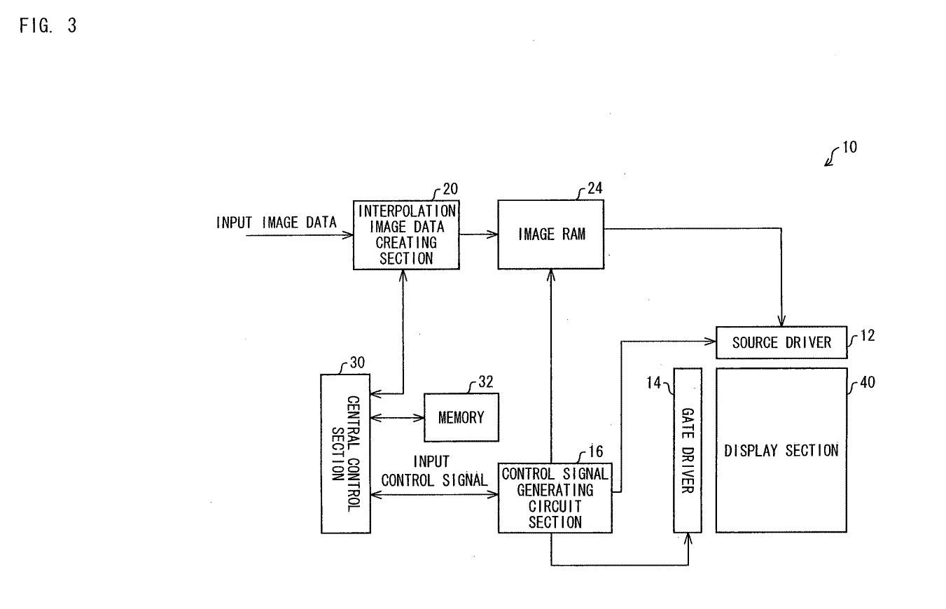

The following description discusses, with reference to FIG. 3, an overall configuration of the liquid crystal display device 10 of the present embodiment. FIG. 3 is a view schematically illustrating how the liquid crystal display device 10 is configured.

The liquid crystal display device 10 of the present embodiment includes various control sections etc. in addition to the liquid crystal display panel 40 serving as the display section, etc.

Specifically, as illustrated in FIG. 3, a source driver 12 and a gate driver 14 are provided around the liquid crystal display panel 40.

Further, the liquid crystal display device 10 includes an image RAM 24, which stores pieces of image data to be supplied to the source driver 12. The image RAM 24 is connected with an interpolation image data creating section 20.

The interpolation image data creating section 20 creates pieces of interpolation image data (described later). The image RAM 24 stores (i) pieces of input image data, which are pieces of original image data and (ii) the pieces of interpolation image data.

Note here that the pieces of original image data (pieces of image data corresponding to respective pixels) mean pieces of image data which are supposed to be supplied to respective corresponding pixels. Specifically, the pieces of original image data mean pieces of image data to be supplied to respective corresponding pixels in a case of for example a normal display device including no optical section.

The pieces of image data (the pieces of original image data and the pieces of interpolation image data) temporarily stored in the image RAM 24 and are then supplied from the image RAM 24 to the source drive 12.

The liquid crystal display device 10 further includes a control signal generating circuit section 16, which controls the source driver 12, the gate driver 14, and the image RAM 24.

The control signal generating circuit section 16 serves also as a control section which selects, from the pieces of image data stored in the image RAM 24, pieces of image data to be supplied to the source driver 12 (i.e., selects thinned-out image data).

The control signal generating circuit section 16 receives an input control signal, in accordance with which the control signal generating circuit section 16 is controlled.

The liquid crystal display device 10 further includes (i) a memory 32 in which a display control program for carrying out the control etc. is stored and (ii) a central control section 30 which is connected with the memory 32.

The central control section 30 controls (i) the control signal generating section 16 by supplying the input control signal and (ii) the interpolation image data creating section 20.

(Display Method)

The following description discusses, in due order, a display method for use in a liquid crystal display device of the present embodiment.

(Magnification Factor)

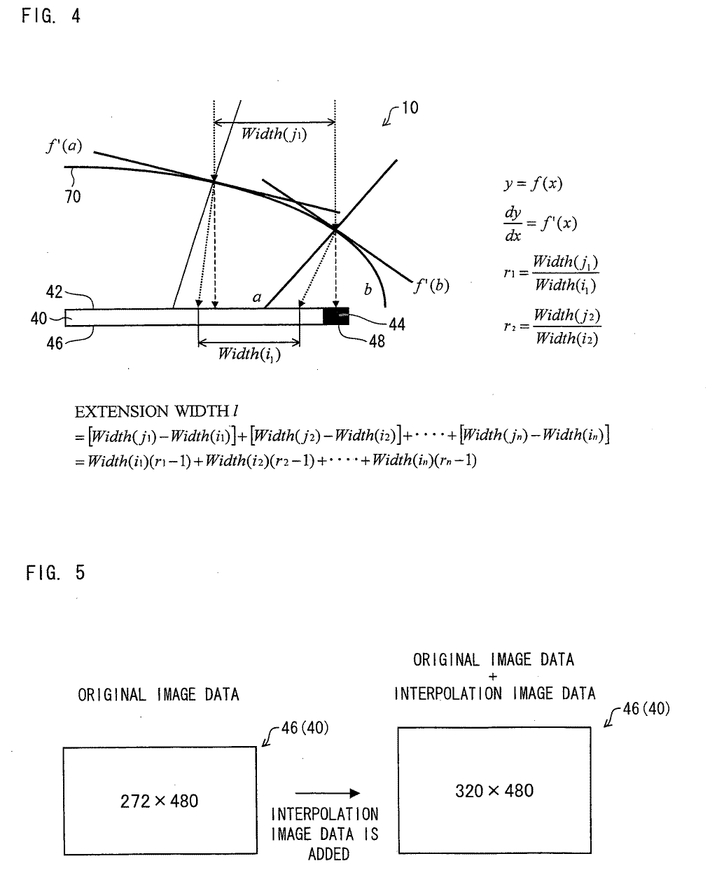

FIG. 4 illustrates how a display is magnified by the lens 70.

In FIG. 4, Width(in) represents a width (a length of part of the display surface) of a certain line zone as seen from a direction normal to the display surface 42.

Further, Width(jn) represents a width (a length of part of the display surface) of the certain line zone (i.e., Width(in)) as seen through the lens 70.

A magnification factor rn of the certain line zone is found by dividing the Width(jn) by the Width(in). That is, the magnification factor rn thus found is a factor by which an image is magnified through the lens 70 serving as the optical section.

The magnification factor rn varies depending on how the lens 70 is curved. Therefore, as illustrated in FIG. 1 described earlier, the magnification factor rn is different from line to line from a boundary between the flat region 70a and the curve region 70b to the end side 44.

(Extension Width)

The following description discusses an extension width of the line zone extended by the lens 70.

An extension width I of the line zone extended by the lens 70 is represented by an equation of Extension width I=Width(jn)−Width(in).

Further, an extension width I in the entire curve region 70 is a summation of the “Width(jn)−Width(in)” of all line zones of the entire curve region 70b (see mathematical formula of FIG. 4).

Note here that f(x) in FIG. 4 is a function representing a shape of a surface of the lens 70, and f′(x) represents an inclination of the f(x).

Further, f′(a) and 1(b) in FIG. 4 represent inclinations of the surface of the lens 70 at positions a and b, respectively.

(Image RAM)

The following description discusses capacity of the image RAM 24. The image RAM 24 stores pieces of image data, which include (i) the pieces of original image data and (ii) the pieces of interpolation image data created in addition to the pieces of original image data. That is, the image RAM 24 is configured so as to store image data for up-converting an image.

Approximate capacity of the image RAM 24, which capacity is necessary for storing the pieces of image data, can be calculated from the number of extension lines to be added. The number of the extension lines to be added can be found through the following equation:

Number of extended lines to be added=Extension width/Pixel pitch (Line pitch)

In a case where the lens 70 is a convex lens which is curved in a direction of vertical lines of the liquid crystal display panel 40, an image is extended to some extent by a radius of curvature of the lens 70. Under such conditions, a difference between a width of an original image and a width of an extended image is found, so as to obtain an extension width. The extension width is divided by a length of a pixel pitch, thereby finding the number of extension lines to be added. Note here that, in a case where the extension width is represented in terms of a length of the display surface, the extension width is a difference between (i) a length of part of the display surface 42 which part faces the curve region 70b and (ii) the length of such part as seen through the lens 70.

Specifically, for example as illustrated in FIG. 5, in a case where the display region 46, of the liquid crystal display panel 40, which has 272 horizontal lines and 480 vertical lines is extended by the convex lens so that the display region 46 thus extended has 320 horizontal lines, the number of extension lines is as follows.

In such a case, the number of the extension lines to be added is 52, which is a difference between the 320 horizontal lines and the 272 horizontal lines. The capacity of the image RAM 24 can be determined in accordance with the number of the extension lines to be added.

Specifically, for example in a case of an RGB display with eight gray scale levels, the image RAM 24 should have capacity sufficient for the number of bits found through the following equation:

Number of bits=52 (Number of extension lines)×480 (Number of vertical lines)×8 (Number of gray scale bits)×3 (R, G, and B)

(Interpolation Image Data)

The following description discusses interpolation image data. Note here that the interpolation image data is image data created to fill a void formed as a result of extension by the lens 70.

In other words, pieces of interpolation image data are pieces of data created in a pseudo manner so that pieces of image data corresponding to respective line zones in the display region keep their size substantially the same when the display region is extended due to an effect of the lens 70. With a combination of the pieces of interpolation image data and the pieces of original image data, it is possible to make a density of pieces of image data substantially the same between a region corresponding to the curve region 70b and a region corresponding to the flat region 70a of the lens 70, even if the extension width results from the effect of the lens 70.

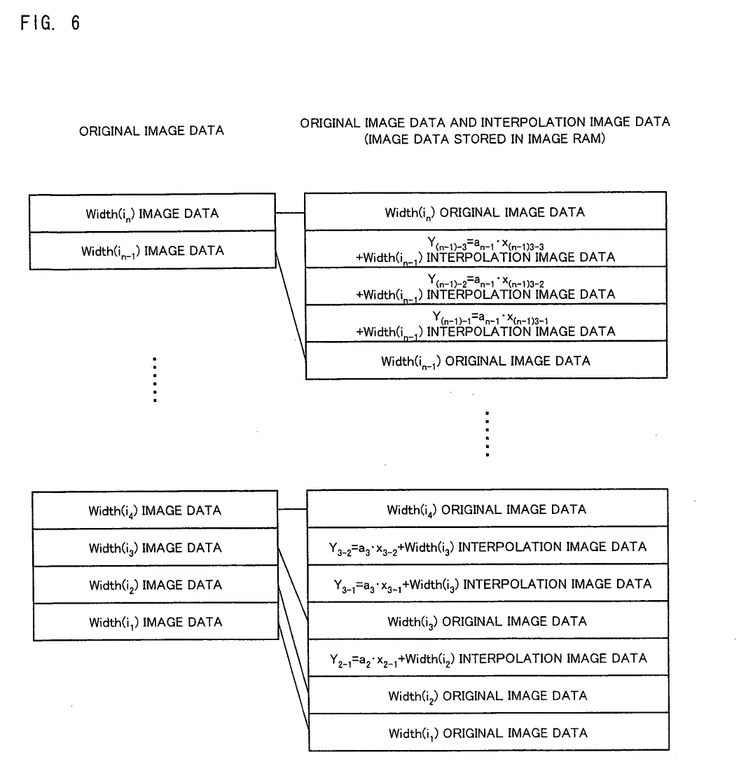

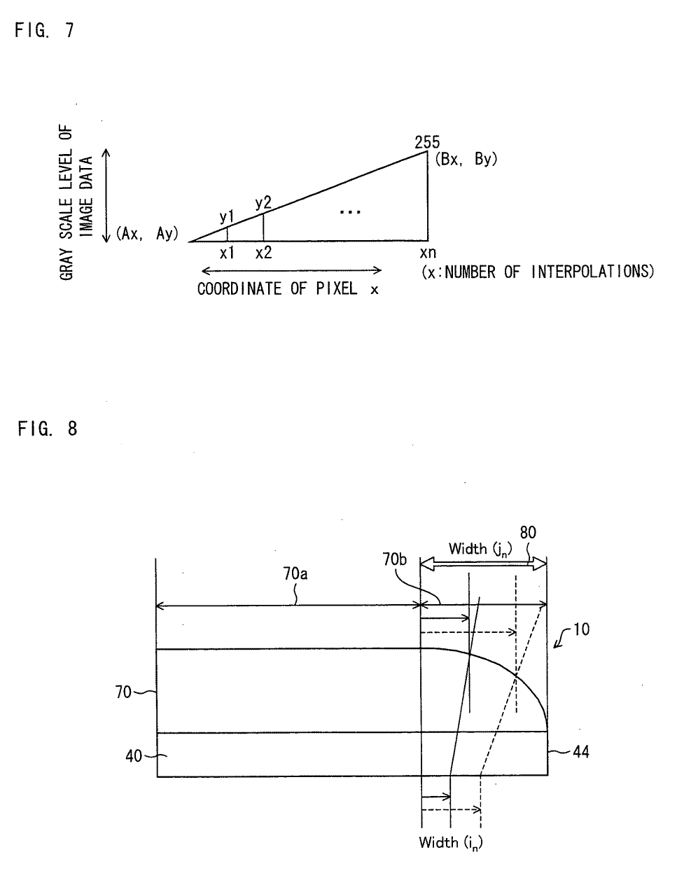

The following description specifically discusses the interpolation image data with reference to FIGS. 6 and 7. FIG. 6 is a view illustrating original image data and interpolation image data. FIG. 6 illustrates the original data in its left part, and both of the original data and the interpolation image data in its right part. FIG. 7 is a view schematically illustrating how the interpolation image data is created.

The following description discusses an example in which pieces of interpolation image data are created for adjacent pixels belonging to respective lines adjacent to each other in a direction in which the curved surface of the curve region 70b of the lens 70 is curved. The pieces of interpolation image data to be created for such adjacent pixels are pieces of image data each having a gray scale level between gray scale levels of respective pieces of original image data which correspond to the adjacent pixels.

Note here that the pixels adjacent to each other in the direction in which the curved surface of the curve region 70b is curved mean that, when the curved surface of the curve region 70b of the lens 70 is seen from its lateral side, the pixels are adjacent to each other in a direction from a curve beginning point (i.e., a boundary between the flat region 70a and the curve region 70b) to a curve ending point.

The pieces of interpolation image data can be created by various methods. The following description discusses how the pieces of interpolation image data are created by using a linear function.

In FIG. 7, the horizontal axis indicates a coordinate of a pixel, whereas the vertical axis indicates brightness (gray scale level) of a piece of image data. That is, in a case where a pixel A has a coordinate of x and a gray scale level of y, the pixel A is represented as (Ax, Ay).

FIG. 7 illustrates an outline of how x pieces of interpolation image data are created between the pixel A (Ax, Ay) and a pixel B (Bx, By).

Specifically, in a case where (i) pieces of reference data are (Ax, Ay) and (Bx, By) and (ii) the number of interpolations is x, a piece(s) of interpolation image data y is represented by the following equation:

y=ax+Ay

where, a=(By−Ay)/x

Further, n-th piece of interpolation image data is represented by the following equation:

yn=axₙ+Ay

As is clear from above, a piece of interpolation image data created is a piece of image data whose gray scale level is located between the gray scale levels of the respective pieces of original image data corresponding to the adjacent pixels at intervals found by dividing, by the number found by adding (1) to the number of the piece of interpolation image data, a difference between the gray scale levels of the respective pieces of original image data corresponding to the adjacent pixels. In a case where two or more pieces of interpolation image data are to be created between a pair of adjacent pixels, the two or more pieces of interpolation image data have respective gray scale levels gradually and continuously increasing or decreasing from a gray scale level of a piece of original image data corresponding to one of the adjacent pixels to a gray scale level of a piece of original image data corresponding to the other one of the adjacent pixels.

The piece of interpolation image data thus found is stored in the image RAM described earlier.

(How to Find Number of Interpolations)

The following description discusses how to find the number of interpolations when creating interpolation image data. The number of interpolations can be found by various methods.

(Method 1)

A first method is a method of incrementing, by one (1), the number of interpolations every time an inequality Width(jn)−Width(in)≧1 is satisfied.

The method is described with reference to FIG. 8. FIG. 8 is a view illustrating how the first number of interpolations is found.

According to the method 1, it is assumed that the Width(in) extends from the boundary between the flat region 70a and the curve region 70b while being divided into divisions. The number of interpolations is incremented by one (1) every time Width(jn)−Width(in) exceeds a width of one (1) line zone, i.e., a pixel pitch (see FIG. 8).

Note that, according to the method 1, the curve region 70b serves as an interpolation image data creation region 80 in which the pieces of interpolation image data are created.

According to the method 1, the pieces of interpolation image data are created in accordance with a factor by which an image is magnified. This makes it easy to substantially equalize (i) a density of pieces of original image data with respect to a length of the display surface of the display section and (ii) a density of a combination of the pieces of interpolation image data and the pieces of original image data with respect to a length of the display surface of the display section as seen through the optical section.

Further, according to the method 1, it is possible to create the pieces of interpolation image data at a desired density only in a region where the pieces of interpolation image data are needed. This makes it possible to reduce the number of pieces of interpolation image data to be created.

Since the number of pieces of interpolation image data is reduced, it is possible for the image RAM 24 to have smaller capacity.

(Method 2)

A method 2 is a method of creating pieces of interpolation image data such that the number of interpolations (steps) is uniform.

According to the method 1, the number of the pieces of interpolation image data differs from interval to interval between lines. On the other hand, according to the method 2, the number of pieces of interpolation image data to be created is uniform throughout all intervals between lines.

The number (i.e., uniform number) of the pieces of interpolation image data to be created is determined in accordance with a factor by which images from corresponding pixels are magnified through the curve region 70b of the lens 70.

The method 1 describes an example in which the pieces of interpolation image data are created only for a part, of the display region 46, which corresponds to the curve region 70b of the lens 70.

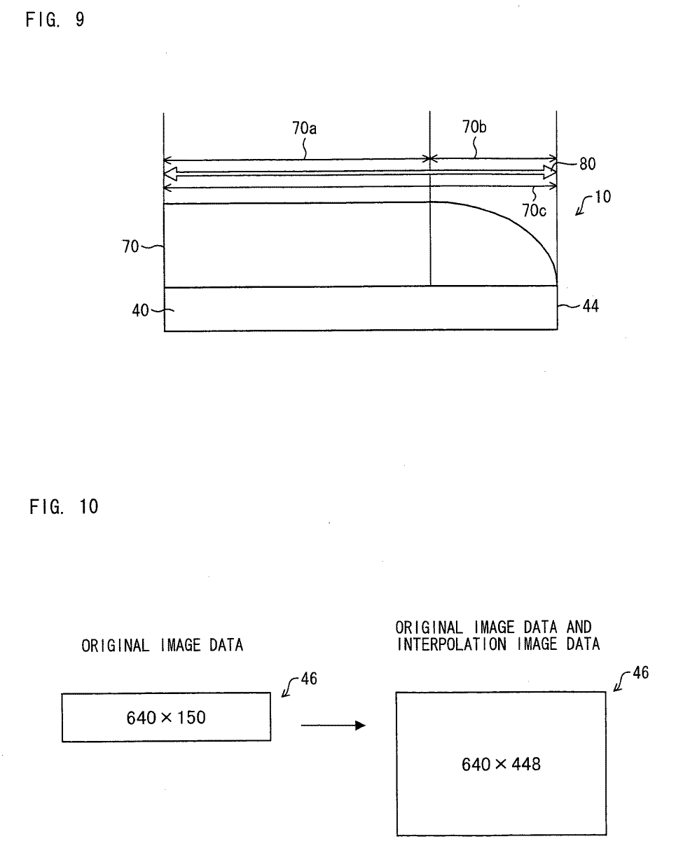

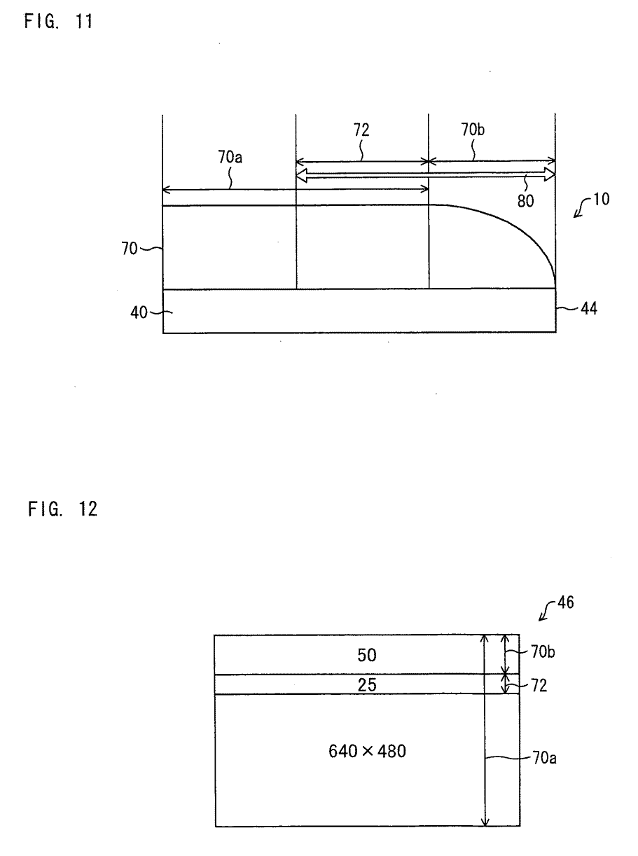

On the other hand, the following description discusses an example in which the pieces of interpolation image data are created not only for the part, of the display region 46, which corresponds to the curve region 70b but also for a part corresponding to the flat region 70a. Specifically, as illustrated in FIG. 9 showing a region in which the pieces of interpolation image data are to be created, the pieces of interpolation image data are created over an entire region 70c of the lens 70 which region includes the flat region 70a and the curve region 70b. That is, the entire region 70c serves as the interpolation image data creation region 80.

FIG. 10 illustrates an example in which the pieces of interpolation image data are created by the method 2.

According to the example, the pieces of interpolation image data are created over the entire display region 46 such that the number of pieces of interpolation image data between any of respective adjacent lines is identical. Specifically, according to the example, (i) the lens 70 is a lens having a maximum magnification factor of approximately an integer of two and (ii) the number of interpolations is two throughout the entire display region 46.

That is, according to the example, the number of the pieces of interpolation image data is determined in accordance with a factor by which images from corresponding pixels are magnified through the curve region 70b of the lens 70, and the number thus found is two.

FIG. 10 illustrates in its left part an example of the display region 46 having pixels of 640×150. Note here that the number of lines corresponding to pieces of original image data is 150.

FIG. 10 illustrates in its right part a pseudo-display region 46 obtained when the pieces of original image data and pieces of interpolation image data are combined. That is, in a case where two pieces of interpolation image data are created for each interval between lines, the number of pieces of interpolation image data obtained is found as follows:

(150−1)×2=298

Accordingly, a summation of the number of the pieces of original image data and the number of the pieces of interpolation image data is 448.

FIG. 10 shows in the right part such a display region 46 which has 448 lines.

Note here that, according to the example, the pieces of interpolation image data are created between horizontal lines, and no interpolation image data is created between vertical lines.

According to the method 2, it is possible to create the pieces of interpolation image data without a complicated calculation. This makes it is possible to create the pieces of interpolation image data with a simple arithmetic circuit.

(Interpolation Image Data Creation Region)

The following description discusses a region in which pieces of interpolation image data are created. The region in which the pieces of interpolation image data are created can be any of various regions.

(Curve Region Only)

The method 1 describes an example in which the pieces of interpolation image data are created in a region, of the display region 46, which is from the boundary between the flat region 70a and the curve region 70b to the end side 44 of the liquid crystal display panel 40.

According to this example, it is possible to minimize the necessary number of pieces of interpolation image data to be created. Accordingly, it is possible for the image RAM 24 to have smaller capacity.

(Entire Region)

The method 2 describes an example in which the pieces of interpolation image data are created over the entire display region 46.

(Partial Flat Region and Curve Region)

The region in which the pieces of interpolation image data are created can be any of various regions besides those described above.

For example, it is possible to create the piece of interpolation image data over a region including (i) the entire curve region 70b and (ii) part of the flat region 70a.

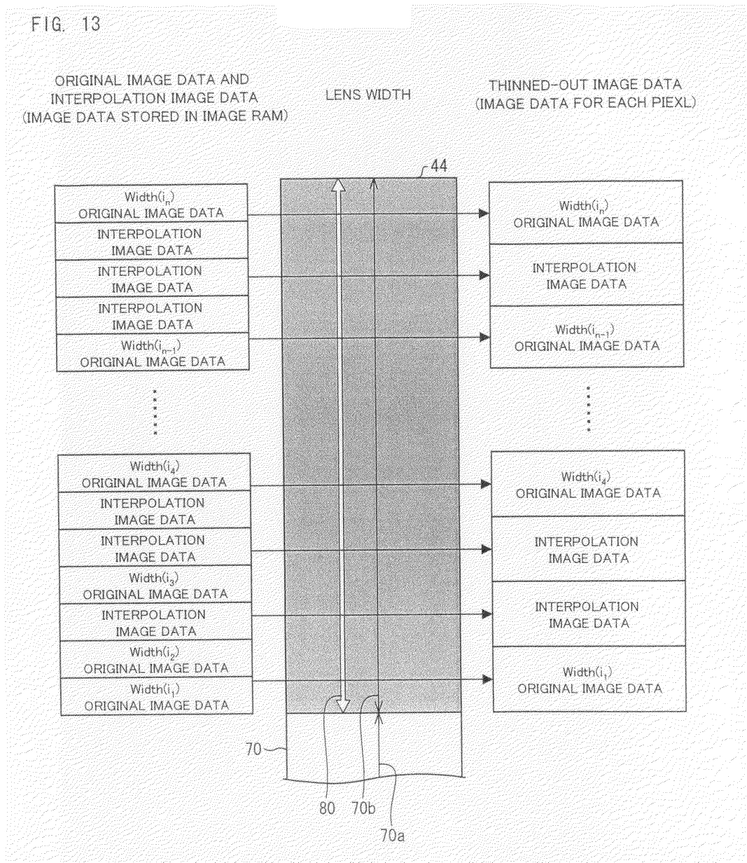

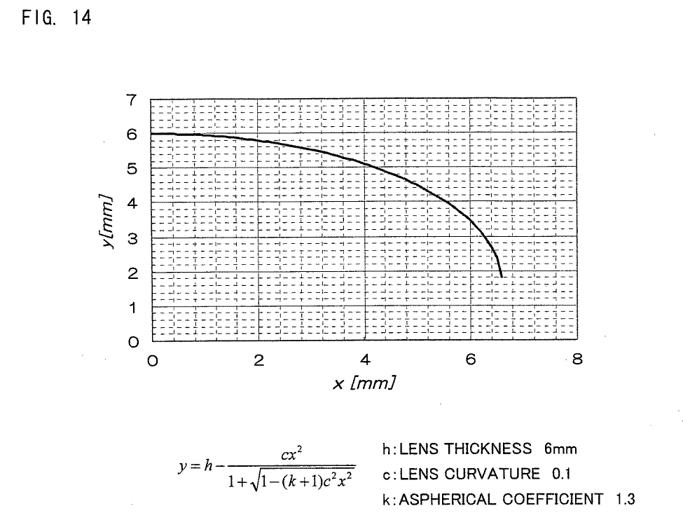

This is described with reference to FIGS. 11 and 12. FIGS. 11 and 12 each illustrate a region in which the pieces of interpolation image data are created.

According to an example shown in FIG. 11, the pieces of interpolation image data are created over a region including (i) the curve region 70b and (ii) an additional flat region 72 which is part of the flat region 70a and is continuous with the curve region 70b. That is, the region including the curve region 70b and the additional flat region 72 (region in the vicinity of the boundary) serves as the interpolation image data creation region 80.

Note here that the additional flat region 72 is not particularly limited as to its size. For example, the additional flat region 72 can be as large as half a size of the curve region 70b.

This is described in detail with reference to FIG. 12. FIG. 12 illustrates the display region 64 having pixels of 640×480. In a case where the curve region 70b has a size corresponding to 50 horizontal lines, the additional flat region 72 can have a size corresponding to approximately 25 horizontal lines.

Note that the size of the additional flat region 72 is not limited to that described above. For example, the additional flat region 72 can have a size corresponding to lines more than 25 lines.

Since the pieces of interpolation image data are created also in the additional flat region 72 like above, it is possible to suppress a display distortion such as an extended display in the vicinity of the boundary between the flat region 70a and the curve region 70b.

Note here that, in a case where the interpolation image data creation region 80 is set to the region shown in FIG. 11, it is not particularly limited as to how the number of interpolations is found. For example, it is possible to employ either the method 1 or the method 2.

(Selection of Thinned-Out Image Data)

The following description discusses selection of thinned-out image data. Note here that the selection of the thinned-out data means that pieces of image data for use in an actual display are selected from the pieces of original image data and the pieces of interpolation image data described earlier with reference to FIG. 6. The selection of the thinned-out image data makes it possible to suppress an extended display caused by the lens 70. This is described below in detail.

The selection of the thinned-out image data is based on the following concept.

That is, in the curve region 70b, pieces of image data, the number of which is the necessary number for a display, are selected from all pieces of image data including the pieces of original image data and the pieces of interpolation image data. Note here that the necessary number of the pieces of image data corresponds to the number of lines.

The pieces of image data are selected so that, in a case where the pieces of original image data and the pieces of interpolation image data are arranged in order, selected pieces of image data (i.e., thinned-out image data) are located at substantially even intervals.

Note here that the phrase “the pieces of original image data and the pieces of interpolation image data are arranged in order” means that (i) the pieces of original image data are arranged in order of corresponding pixels and (ii) between adjacent ones of the pieces of original image data, a corresponding piece(s) of interpolation image data is arranged so as to have a continuous gray scale level(s).

This is described below in detail with reference to FIG. 13. FIG. 13 is a view illustrating how the thinned-out image data is selected. FIG. 13 shows pieces of image data (image data group) including pieces of original image data and pieces of interpolation image data in the left part, and shows the thinned-out image data in the right part.

The pieces of interpolation image data of FIG. 13 are same as those described earlier with reference to FIG. 6. That is, the interpolation image data creation region 80 in which the pieces of interpolation image data of FIG. 13 are created is the curve region 70b. The pieces of interpolation image data are created by the method 1 so that the number of pieces of interpolation image data between adjacent lines increases from the boundary between the flat region 70a and the curve region 70b toward the end side 44.

According to the present embodiment, pieces of image data, the number of which is the necessary number for a display, are selected from the pieces of the original image data and the pieces of interpolation image data. That is, pieces of image data as many as the lines are selected. Note here that the selection is carried out so that, in a case where the pieces of original image data and the pieces of interpolation image data are arranged in order, selected pieces of image data are located at substantially even intervals.

The selection as above makes it possible to easily select, from pieces of image data stored in the image RAM 24, pieces of image data (i.e., the thinned-out image data) which are for use in a display and are suitable for a lens width and line zones (pixel pitch). Note here that the lens width is a length of a part of the lens 70 which part has a curvature. That is, the lens width is equivalent to a length of the curve region 70b.

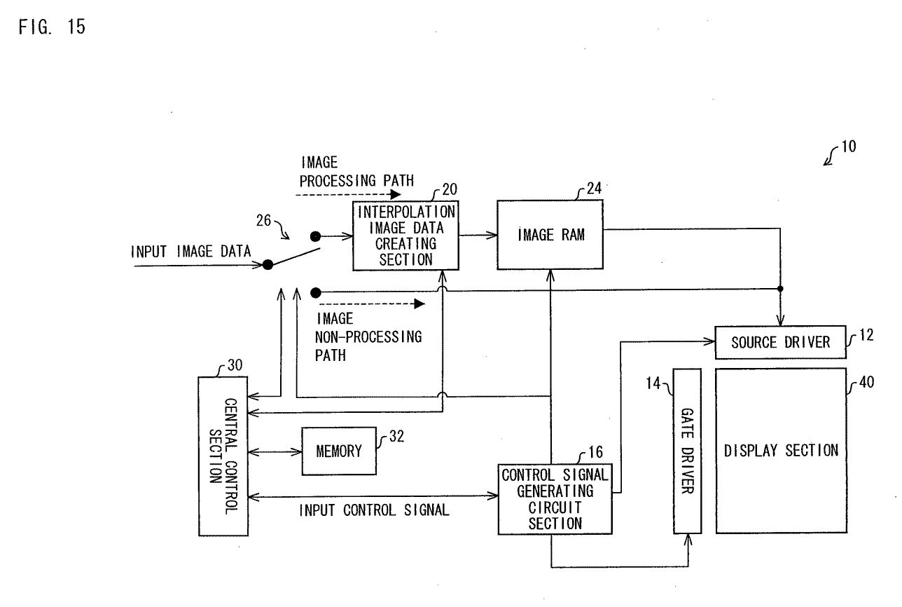

The following description discusses, with reference to FIG. 14, one example of the lens 70 and its lens width. FIG. 14 is a view illustrating a relation between a radius of curvature and the lens width of the lens 70. According to a graph of FIG. 14, (i) the horizontal axis indicates a lens width, which is a length of a part of the lens 70 which part has a curvature and (ii) the vertical axis indicates a radius of curvature of the lens 70.

FIG. 14 exemplifies the lens 70 which is 6 mm in thickness (lens thickness) and 6.5 mm in lens width.

The radius of curvature of the lens 70 is related to the lens width etc. of the lens 70 so that an equation shown in FIG. 14 is satisfied.

In a case where the lens 70 illustrated in the middle of FIG. 13 is same as the lens 70 of FIG. 14, the lens 70 of FIG. 13 is 6.5 mm in lens width. Further, the curve region 70b of FIG. 13 is 6.5 mm, and the interpolation image data creation region 80 is also 6.5 mm. This is because, according to the example of FIG. 13, the curve region 70b serves as the interpolation image data creation region 80.

Note here that, in the foregoing description regarding the selection of the thinned-out image data, how the thinned-out image data is selected in the curve region 70b is discussed on the assumption that the pieces of interpolation image data are created only for the curve region 70b.

On the other hand, in a case where the method 2 of finding the number of interpolations is employed, i.e., in a case where the pieces of interpolation image data are created not only for a part of the display region 46 which part corresponds to the curve region 70b but also for a part corresponding to the flat region 70a, the selection of the thinned-out image data can be carried out only for the curve region 70b and not for the flat region 70a. That is, in the flat region 70a, although pieces of interpolation image data are created, pieces of original image data alone can be directly used for a display.

According to this configuration, it is possible to easily find the pieces of interpolation image data and to achieve an excellent display both in the flat region 70a and the curve region 70b.

(Another Configuration of Image RAM)

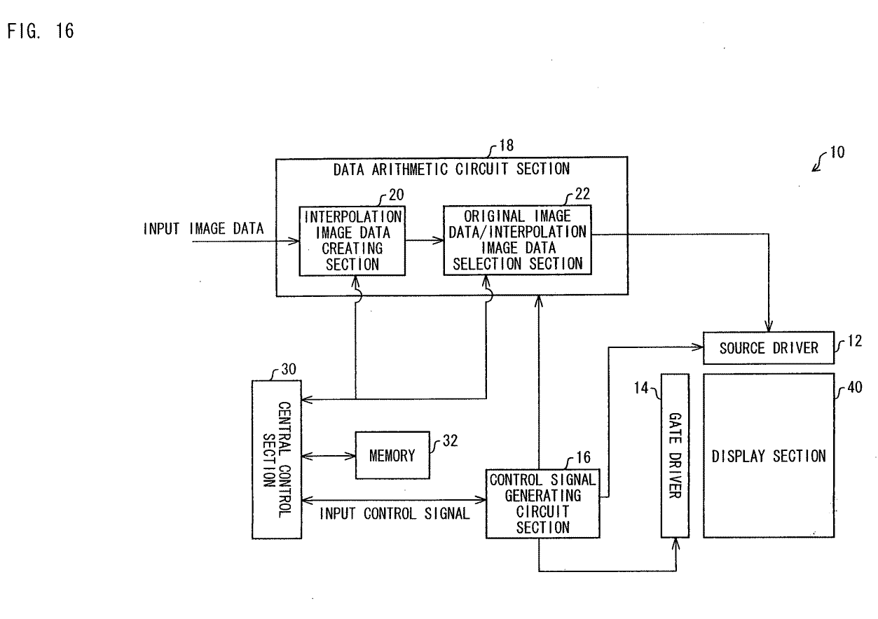

The following description discusses, with reference to FIG. 15, another configuration of the image RAM 24. FIG. 15 is a view schematically illustrating how a liquid crystal display device 10 including a path changeover switch is configured.

According to the configuration described earlier with reference to FIG. 3, pieces of input image data are all supplied to the source driver 12 via the image RAM 24. In contrast, according to the configuration of FIG. 15, the pieces of input image data are (i) temporarily stored in the image RAM 24 and thereafter supplied from the image RAM 24 to the source driver 12 or (ii) supplied directly to the source driver 12 without being stored in the image RAM 24. This is described below in detail.

The liquid crystal display device 10 of FIG. 15 is different from the liquid crystal display device 10 of FIG. 3 in that the liquid crystal display device 10 of FIG. 15 includes a path changeover switch 26. That is, the liquid crystal display device 10 of FIG. 15 includes the path changeover switch 26 in addition to the liquid crystal display panel 40, the source driver 12, the gate driver 14, the control signal generating circuit section 16, and a data arithmetic circuit section 18.

The path changeover switch 26 is provided before the image RAM 24, i.e., on an input side of the image RAM 24. The path changeover switch 26 is controlled by the central control section 30. The path changeover switch 26 makes it possible to switch between (i) supplying the pieces of input image data to an image processing path and (ii) supplying the pieces of input image data to an image non-processing path.

Note here that the image processing path means a path in which the pieces of interpolation image data are created on the basis of the pieces of input image data (original image data).

On the other hand, the image non-processing path is a path in which the pieces of input image data are directly supplied to the source driver 12, without being processed so that the pieces of interpolation image data are created.

The following description discusses a case of supplying the pieces of input image data to the image processing path by turning the path changeover switch 26.

In this case, the pieces of input image data are first supplied to the interpolation image data creating section 20 provided on the input side of the image RAM 24. Next, in the interpolation image data creating section 20, pieces of interpolation image data are created on the basis of the pieces of input image data (i.e., pieces of original image data). Next, the pieces of original image data and the pieces of interpolation image data are stored in the image RAM 24. Then, in response to a control by the control signal generating circuit 16 serving as a control section, the earlier-described selection of the thinned-out image data is carried out and thereafter pieces of image data are supplied from the image RAM 24 to the source driver 12.

The following description discusses a case of supplying the pieces of input image data to the image non-processing path.

In this case, the pieces of input image data are directly supplied to the source driver 12 without being stored in the image RAM 24.

Further, turning the path changeover switch 26 in the following manner makes it possible to minimize necessary capacity of the image RAM 24.

That is, in a case where the pieces of input image data are pieces of image data corresponding to the interpolation image data creation region described earlier, the path changeover switch 26 is turned so that the pieces of input image data are supplied to the image processing path. On the other hand, in a case where the pieces of input image data are pieces of image data corresponding to a region other than the interpolation image data creation region, the path changeover switch 26 is turned so that the pieces of input image data are supplied to the image non-processing path.

By turning the path change over switch 26 like above so as to switch between routes to which the pieces of input image data are to be supplied, it is possible to minimize necessary capacity of the image RAM 24.

The path changeover switch 26 is controlled by the control signal generating circuit section 16 so as to be turned in accordance with an input control signal.

The interpolation image data creating section 20 can be provided on an input side of the path changeover switch 26.

This configuration also makes it possible to minimize necessary capacity of the image RAM 24, by turning the path changeover switch 26 in the same manner as in the case where the interpolation image data creating section 20 is provided on an output side of the path changeover switch 26 (see FIG. 15).

### Embodiment 2

The following description discusses, with reference to FIG. 16, another embodiment of a liquid crystal display device 10 in accordance with the present invention. FIG. 16 is a view schematically illustrating how the liquid crystal display device 10 of the present embodiment is configured.

For convenience of description, members having functions identical to those illustrated in the drawings of Embodiment 1 are assigned identical referential numerals, and their descriptions are omitted here.

The liquid crystal display device 10 of the present embodiment is different from the liquid crystal display device 10 of Embodiment 1 described with reference to FIGS. 3 and 15 in that the liquid crystal display device 10 of the present embodiment includes no image RAM 24. Further, the liquid crystal display device 10 of the present embodiment includes the data arithmetic circuit section 18. This is described below in detail.

As illustrated in FIG. 16, the liquid crystal display device 10 of the present embodiment includes the data arithmetic circuit section 18, which supplies an image signal to the source driver 12. The data arithmetic circuit section 18 includes the interpolation image data creating section 20 and an original image data/interpolation image data selection section 22, which are controlled by the central control section 30.

The data arithmetic circuit section 18 is connected with the control signal generating circuit section 16. The data arithmetic circuit section 18 is controlled, in accordance with an input control signal supplied to the control signal generating circuit section 16, by the control signal generating circuit section 16 which serves as the control section.

The interpolation image data creating section 20 of the data arithmetic circuit section 18 has a function identical to the interpolation image data creating section 20 of the liquid crystal display device 10 of Embodiment 1. Specifically, the interpolation image data creating section 20 of the data arithmetic circuit section 18 creates pieces of interpolation image data on the basis of the pieces of input image data (original image data) supplied to the interpolation image data creating section 20. Then, the original image data/interpolation image data selection section 22, which is also included in the data arithmetic circuit section 18, selects the earlier-described thinned-out image data from created pieces of interpolation image data and the piece of original image data.

Then, the thinned-out image data thus selected is supplied to the source driver 12.

According to the liquid crystal display device 10 of the present embodiment, the data arithmetic circuit section 18 creates the pieces of interpolation image data and selects the thinned-out image data. Therefore, there is no need to provide the image RAM 24 for storing the pieces of interpolation image data. This makes it possible to simplify the configuration of the liquid crystal display device 10.

Note here that, in the foregoing descriptions, the preferred number of interpolations etc. may be other than integers depending on for example the magnification factor. In such a case, for example the number of interpolations can be rounded off to an integer. Alternatively, it is possible to find an additional piece of interpolation image data so as to fill a void as appropriate.

Further, in the selection of the thinned-out image data, it may be impossible to select the thinned-out image data so that pieces of image data are at even intervals, depending on the number of the pieces of original image data and the pieces of interpolation image data etc. In such a case, the thinned-out image data can be selected so that the pieces of image data are at substantially even intervals as close as possible to the even intervals, as appropriate.

The invention is not limited to the description of the embodiments above, but may be altered within the scope of the claims. An embodiment based on a proper combination of technical means disclosed in different embodiments is encompassed in the technical scope of the invention.

Further, the display device in accordance with the present invention is configured such that said at least one piece of interpolation image data has a gray scale level(s) which is located between the gray scale levels of the corresponding pieces of original image data corresponding to the respective adjacent pixels at intervals found by dividing, by the number found by adding one (1) to the number of said at least one piece of interpolation image data, a difference between the gray scale levels of the corresponding pieces of original image data corresponding to the respective adjacent pixels.

According to the configuration, said at least one piece of interpolation image data to be created has the gray scale level(s) equally spaced between the gray scale levels of the corresponding pieces of original image data corresponding to the respective adjacent pixels.

Accordingly, the pieces of image data thus selected are to have continuous gray scale levels. This makes it easy to achieve a more natural display in which an extended display is suppressed.

Further, the display device in accordance with the present invention is configured such that said at least one piece of interpolation image data is created so that (i) a density of the pieces of original image data with respect to a length of the display surface of the display section and (ii) a density of the pieces of original image data and said at least one piece of interpolation image data with respect to the length of the display surface of the display section as seen through the optical section are substantially equal to each other.

According to the configuration, the density of the pieces of original image data with respect to the length of the display surface of the display section is substantially equal to the density of the pieces of original image data and said at least one piece of interpolation image data with respect to the length of the display surface of the display section as seen through the optical section.

This makes it possible to further suppress an effect of the lens on a display, thereby further suppressing a magnified and extended display.

Further, the display device in accordance with the present invention is configured such that, in a case where the display surface extends from a boundary between the flat region and the curve region of the lens toward the curve region while being divided into divisions, the number of said at least one piece of interpolation image data to be created is incremented by one (1) every time a difference between a length of each of the divisions and a length of said each of the divisions as seen through the optical section increases by a length of a pitch at which the pixels are arranged.

According to the configuration, it is possible to find more accurately the number of said at least one piece of interpolation image data in accordance with the factor by which the image is magnified through the curve region of the optical section.

Further, the display device in accordance with the present invention is configured such that the number of said at least one piece of interpolation image data to be created for the adjacent pixels is a uniform number determined in accordance with the factor by which the images from the pixels are magnified through the curve region of the optical section.

This configuration makes it possible to simplify a calculation etc. for finding the number of said at least one piece of interpolation image data to be created.

Further, the display device in accordance with the present invention is configured such that said at least one piece of interpolation image data is created only for corresponding ones, of the pixels, which are adjacent to each other in the region facing the curve region.

According to the configuration, said at least one piece of interpolation image data is created only for the curve region, in which the image tends to be extended. This makes it possible to reduce the number of said at least one piece of interpolation image data to be created, thereby making it possible to more easily suppressing an extended display.

Further, the display device in accordance with the present invention is configured such that said at least one piece of interpolation image data is created for corresponding ones, of the pixels, which are adjacent to each other in a region including the region facing the curve region and a region in the vicinity of a boundary between the curve region and the flat region.

According to the configuration, said at least one piece of interpolation image data is created also for the region in the vicinity of the boundary between the curve region and the flat region.

This makes it possible to suppress a display distortion, such as an extended display, which tends to occur in the region in the vicinity of the boundary between the curve region and the flat region.

Further, the display device in accordance with the present invention is configured such that said at least one piece of interpolation image data is created in the entire display surface of the display section.

According to the configuration, there is no need to carry out calculation etc. for finding the number of said at least one piece of interpolation image data to be created for each interval between lines. This makes it possible to suppress an extended display with a simple arithmetic circuit.

Further, the display device in accordance with the present invention further includes: an image RAM for storing the pieces of original image data and said at least one piece of interpolation image data, the control section selecting, from the pieces of original image data and said at least one piece of interpolation image data stored in the image RAM, pieces of image data for use in a display.

According to the configuration, the display device includes the image RAM for storing the pieces of original image data and said at least one piece of interpolation image data. This makes it possible to simplify a configuration of the control section. Further, since the image RAM is provided, it is possible to carry out a control excellent in versatility even if for example a radius of curvature of the lens is changed.

Further, the display device in accordance with the present invention is configured such that the image RAM has capacity determined in accordance with a value found by dividing, by a pitch at which the pixels are arranged, a difference between a length of a part of the display surface which part faces the curve region and a length of the part of the display surface as seen through the optical section.

According to the configuration, the capacity of the image RAM is determined in accordance with to what degree the display is extended through the optical section. This makes it easy to determine the necessary capacity of the image RAM.

Further, a display control program in accordance with the present invention is a display control program for causing a computer to function as the interpolation image data creating section and the control section of the foregoing display device.

Further, a storage medium in accordance with the present invention is a computer-readable storage medium in which the foregoing display control program is stored.

### INDUSTRIAL APPLICABILITY

The display device in accordance with the present invention has a simple configuration and is capable of suppressing an extended display. Therefore, the display device in accordance with the present invention is suitably applicable to a mobile terminal etc. including a display section, such as for example a gaming device.

### REFERENCE SIGNS LIST

10 Liquid crystal display device (Display device)
12 Source driver
14 Gate driver
16 Control signal generating circuit section (Control section)
18 Data arithmetic circuit section
20 Interpolation image data creating section
22 Original image data/interpolation image data selection section (Control section)
24 Image RAM
26 Path changeover switch
30 Central control section
32 Memory
40 Liquid crystal display panel (Display section)
42 Display surface
44 End side
46 Display region
48 Non-display region
70 Lens (Optical section)
70a Flat region
70b Curve region
70c Entire region
72 Additional flat region
80 Interpolation image data creation region

1. A display device, comprising:
a display section;
an optical section which covers a display surface of the display section;
an interpolation image data creating section; and
a control section,
the display section having pixels arranged in a matrix manner,
the optical section including a lens having (i) a flat region having a flat surface and (ii) a curve region having a convexly curved surface,
the pixels corresponding to respective pieces of image data which serve as pieces of original image data,
the interpolation image data creating section creating at least one piece of interpolation image data for adjacent pixels which are in a region facing the curve region and adjacent to each other in a direction from a curve beginning point toward a curve ending point of the curved surface, said at least one piece of interpolation image data having a gray scale level(s) between gray scale levels of corresponding pieces of original image data corresponding to the respective adjacent pixels, and
the control section selecting pieces of image data from the pieces of original image data and said at least one piece of interpolation image data so that, in a case where (a) the pieces of original image data are arranged in order of corresponding pixels and (b) said at least one piece of interpolation image data is arranged between the corresponding pieces of original image data corresponding to the respective adjacent pixels so that said at least one piece of interpolation image data thus arranged has a continuous gray scale level(s), the pieces of image data thus selected are at substantially even intervals and the number of the pieces of image data thus selected is same as the number of the corresponding pixels.

2. The display device according to claim 1, wherein the number of said at least one piece of interpolation image data to be created is determined in accordance with a factor by which images from the pixels are magnified through the curve region of the optical section.

3. The display device according to claim 1, wherein the number of said at least one piece of interpolation image data to be created is determined in accordance with a factor by which an image from a corresponding one of the pixels is magnified through the curve region of the optical section.

4. The display device according to claim 1, wherein said at least one piece of interpolation image data has a gray scale level(s) which is located between the gray scale levels of the corresponding pieces of original image data corresponding to the respective adjacent pixels at intervals found by dividing, by the number found by adding one (1) to the number of said at least one piece of interpolation image data, a difference between the gray scale levels of the corresponding pieces of original image data corresponding to the respective adjacent pixels.

5. The display device according to claim 3, wherein said at least one piece of interpolation image data is created so that (i) a density of the pieces of original image data with respect to a length of the display surface of the display section and (ii) a density of the pieces of original image data and said at least one piece of interpolation image data with respect to the length of the display surface of the display section as seen through the optical section are substantially equal to each other.

6. The display device according to claim 3, wherein, in a case where the display surface extends from a boundary between the flat region and the curve region of the lens toward the curve region while being divided into divisions, the number of said at least one piece of interpolation image data to be created is incremented by one (1) every time a difference between a length of each of the divisions and a length of said each of the divisions as seen through the optical section increases by a length of a pitch at which the pixels are arranged.

7. The display device according to claim 2, wherein the number of said at least one piece of interpolation image data to be created for the adjacent pixels is a uniform number determined in accordance with the factor by which the images from the pixels are magnified through the curve region of the optical section.

8. The display device according to claim 1, wherein said at least one piece of interpolation image data is created only for corresponding ones, of the pixels, which are adjacent to each other in the region facing the curve region.

9. The display device according to claim 1, wherein said at least one piece of interpolation image data is created for corresponding ones, of the pixels, which are adjacent to each other in a region including the region facing the curve region and a region in the vicinity of a boundary between the curve region and the flat region.

10. The display device according to claim 1, wherein said at least one piece of interpolation image data is created in the entire display surface of the display section.

11. A display device according to claim 1, further comprising:
an image RAM for storing the pieces of original image data and said at least one piece of interpolation image data,
the control section selecting, from the pieces of original image data and said at least one piece of interpolation image data stored in the image RAM, pieces of image data for use in a display.

12. The display device according to claim 11, wherein the image RAM has capacity determined in accordance with a value found by dividing, by a pitch at which the pixels are arranged, a difference between a length of a part of the display surface which part faces the curve region and a length of the part of the display surface as seen through the optical section.

13. A display method for use in a display device including:
a display section; and
an optical section which covers a display surface of the display section;
the display section having pixels arranged in a matrix manner,
the optical section including a lens having (i) a flat region having a flat surface and (ii) a curve region having a convexly curved surface,
the pixels corresponding to respective pieces of image data which serve as pieces of original image data,
said method, comprising the steps of:
creating at least one piece of interpolation image data for adjacent pixels which are in a region facing the curve region and adjacent to each other in a direction from a curve beginning point toward a curve ending point of the curved surface, said at least one piece of interpolation image data having a gray scale level(s) between gray scale levels of corresponding pieces of original image data corresponding to the respective adjacent pixels;
selecting pieces of image data from the pieces of original image data and said at least one piece of interpolation image data so that, in a case where (a) the pieces of original image data are arranged in order of corresponding pixels and (b) said at least one piece of interpolation image data is arranged between the corresponding pieces of original image data corresponding to the respective adjacent pixels so that said at least one piece of interpolation image data thus arranged has a continuous gray scale level(s), the pieces of image data thus selected are at substantially even intervals and the number of the pieces of image data thus selected is same as the number of the corresponding pixels; and
displaying the pieces of image data thus selected.

14. The method according to claim 13, wherein the number of said at least one piece of interpolation image data to be created is determined in accordance with a factor by which images from the pixels are magnified through the curve region of the optical section.

15. A display control program for causing a computer to function as the interpolation image data creating section and the control section of a display device recited in claim 1.

16. A computer-readable storage medium in which a display control program recited in claim 15 is stored.
